(19) United States
(12) Patent Application Publication
(10) Pub. No.: US 2010/0190636 A1
(43) Pub. Date: Jul. 29, 2010

(54) PROCESSES FOR MAKING CATALYST ACTIVATORS

(75) Inventor: Jamie R. Strickler, Baton Rouge, LA (US)

Correspondence Address: ALBEMARLE CORPORATION;PATENT DEPARTMENT, 451 FLORIDA STREET, BATON ROUGE, LA, 70801, US

(73) Assignee: ALBEMARLE CORPORATION, Baton Rouge, LA (US)

(21) Appl. No.: 12/671,393

(22) PCT Filed: Aug. 1, 2008
(86) PCT No.: PCT/US2008/071874

§ 371 Date: Jan. 29, 2010

Related U.S. Application Data
(60) Provisional application No. 60/953,396, filed on Aug. 1, 2007.

(51) Int. Cl. B01J 31/12

(52) U.S. Cl. 502/156

(57) ABSTRACT

Processes are provided for producing activators, wherein the processes comprise use of borane compositions that are at least 95 mol % pure and trialkylsilyl halides such as R²R³R⁴SiX², where R² is ethyl (Et), isopropyl (ⁱPr), or phenyl (Ph), R³ is methyl (Me), ethyl (Et), or phenyl (Ph), and R⁴ is methyl (Me) or ethyl (Et), Si is silicon, and X is a suitable halide, such as Cl (chloride), F (fluoride), B (bromide), or I (iodide).

This invention relates to catalyst activators for olefin polymerization.

It is known to use supported catalysts for olefin polymerization. For example, a supported catalyst can comprise (i) an organometallic compound, such as one in which the metal is a “transition metal” from groups 2-13 of the Periodic Table (particularly those metal complexes which contain delocalized pi ligands and are known as “metallocene catalysts”), (ii) an activator, and optionally (iii) a support material, such as silica.

It is known to use an activator compound comprising (i) a cation which is capable of reacting with a transition metal compound to form a catalytically active transition metal complex, and (ii) a compatible anion having up to 100 nonhydrogen atoms and containing at least one substituent comprising an active hydrogen moiety. Such activator compounds and methods for producing same are described in detail in U.S. Pat. Nos. 5,834,393 and 6,087,293. However, such activators are expensive, primarily due to the complex processes used to produce them.

Accordingly, there is a need for improved processes for producing such activators, particularly such processes that are commercially suitable for producing the anion portion thereof.

This invention meets the above-described needs by providing methods of producing an activator comprising: combining at least a halogenated phenol, a first amine and a trialkylsilyl halide to produce at least a protected phenol, wherein the trialkylsilyl halide comprises R²R³R⁴SiX², where R² is ethyl (Et), isopropyl (ⁱPr), or phenyl (Ph), R³ is methyl (Me), ethyl (Et), or phenyl (Ph), and R⁴ is methyl (Me) or ethyl (Et), Si is silicon, and X² is Cl (chloride), F (fluoride), B (bromide), or I (iodide); combining at least the protected phenol and M to produce a Grignard or an aryllithium, where M comprises magnesium, lithium, or a lithium source; combining at least the Grignard or aryllithium and a borane composition to produce at least an intermediate borate, wherein the borane composition comprises at least about 95 mol % borane; and combining at least the intermediate borate, an acid composition, and a second amine to produce at least the activator.

A first step of processes of this invention comprises combining at least a halogenated phenol, a first amine and a trialkylsilyl halide to produce at least a protected phenol. Suitable solvent, e.g., THF (tetrahydrofuran), can also be combined with the halogenated phenol, amine and trialkylsilyl halide. Suitable halogenated phenols include X¹C₆H₄OH, where X¹ is Br (bromide), Cl (chloride), or I (iodide), C is carbon, H is hydrogen, and O is oxygen. Suitable amines include R¹₃N, where R¹ is an aryl or an aliphatic group, or R¹₃N is a heterocyclic nitrogen compound such as pyridine. Suitable trialkylsilyl halides include R²R³R⁴SiX², where R² is ethyl (Et), isopropyl (ⁱPr), or phenyl (Ph), R³ is methyl (Me), ethyl (Et), or phenyl (Ph), and R⁴ is methyl (Me) or ethyl (Et), Si is silicon, and X² is a suitable halide, such as Cl (chloride), F (fluoride), B (bromide), or I (iodide).

An exemplary first process step according to this invention comprises:

X¹C₆H₄OH+R¹₃N+R²R³R⁴SiX²→X¹C₆H₄OSiR²R³R⁴+NR¹₃HX², or e.g.,

BrC₆H₄OH+Et₃N+Et₃SiCl→BrC₆H₄OSiEt₃+NEt₃HCl, or e.g.,

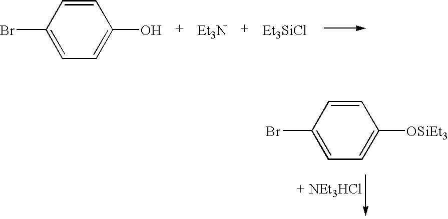

A second step of processes of this invention comprises combining at least the protected phenol from the first step, e.g., X¹C₆H₄OSiR²R³R⁴, and M to produce at least a Grignard or an aryllithium, where M is Mg (magnesium), Li (lithium), or a suitable source of Li, e.g., an alkyl lithium R⁶Li, where R⁶ is a suitable alkyl such as butyl or n-butyl. For the formation of Grignards from Mg metal, suitable activation techniques are well know in the art; see, e.g., Organomagnesium Methods in Organic Synthesis by Basil Wakefield, 1995 and/or Organic Process Research and Development 2002, 6, 906-910. Suitable solvents, e.g., THF (tetrahydrofuran), and suitable initiator/activator, e.g., BrCH₂CH₂Br, can also be combined with the M.

An exemplary second process step according to this invention comprises:

X¹C₆H₄OSiR²R³R⁴+Mg→X¹MgC₆H₄OSiR²R³R⁴, or e.g.,

BrC₆H₄OSiEt₃+Mg→BrMgC₆H₄OSiEt₃, or e.g.,

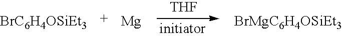

or

X¹C₆H₄OSiR²R³R⁴+2Li→LiC₆H₄OSiR²R³R⁴+LiX¹, or e.g.,

BrC₆H₄OSiEt₃+2Li→LiC₆H₄OSiEt₃+LiBr

or

X¹C₆H₄OSiR²R³R^{4+R}⁶+Li→LiC₆H₄OSiR²R³R⁴+R⁶X¹, or e.g.,

BrC₆H₄OSiEt₃+nBuLi→LiC₆H₄OSiEt₃+nBuBr

Another exemplary second process step according to this invention comprises:

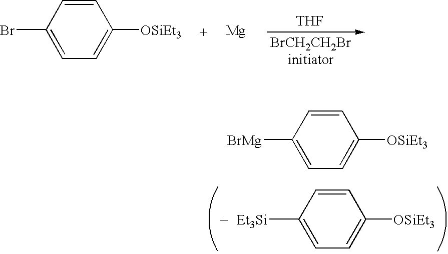

In this example, the production of the by-product, Et₃SiC₆H₄OSiEt₃, occurs as a side reaction.

A third step of processes of this invention comprises combining at least the Grignard or aryllithium from the second step, e.g., X¹MgC₆H₄OSiR²R³R⁴ or LiC₆H₄OSiR²R³R⁴ and a suitable borane to produce at least an intermediate borate. Suitable boranes include B(C₆F₅)₃. Other suitable boranes include partially fluorinated aromatics with alkyl substituents and other perfluoroboranes, e.g., tris(nonafluorobiphenyl)borane and tris(perfluoronapthyl)borane; see, e.g., J. Am. Chem. Soc, 1998, 120, 6287 and U.S. Pat. No. 6,635,597. Suitable solvent comprising THF, toluene, and the like, can also be combined with the Grignard and borane. In at least one process of this invention, the borane used is a borane composition comprising at least about 95 mol % pure borane, or at least about 98 mol % pure borane, or at least about 99 mol % pure borane—the purity being measured by ¹⁹F NMR. For example, a borane useful in this invention that is at least about 98 mol % pure comprises at least about 98 mol % B(C₆F₅) (as measured by ¹⁹F NMR) and less than about 2 mol % impurities that typically result from production of B(C₆F₅). In at least one process of this invention, the Grignard and borane are combined in stoichiometric amounts. In at least one process of this invention, the Grignard is combined in less than about 8% stoichiometric excess as to the borane.

An exemplary third process step according to this invention comprises:

B(C₆F₅)₃+X¹MgC₆H₄OSiR²R³R⁴→X¹Mg⁺[B(C₆F₅)₃(C₆H₄OSiR²R³R⁴)]⁻, or e.g.,

B(C₆F₅)₃+BrMgC₆H₄OSiEt₃→BrMg⁺[B(C₆F₅)₃(C₆H₄OSiEt₃)]⁻

or

B(C₆F₅)₃+LiC₆H₄OSiR²R³R⁴→Li⁺[B(C₆F₅)₃(C₆H₄OSiR²R³R⁴)]⁻, or e.g.,

Another exemplary third process step according to this invention comprises:

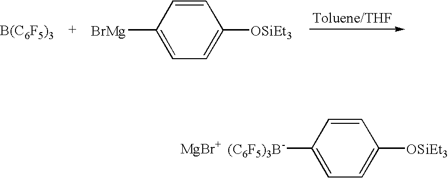

A fourth step of processes of this invention comprises combining at least the intermediate borate from the third step, e.g., X¹Mg⁺[B(C₆F₅)₃(C₆H₄OSiR²R³R⁴)]⁻, an acid, such as aqueous HCl (hydrochloride), and a second amine to produce at least a final borate. Suitable acids comprise acetic acid, hydrochloric acid, hydrobromic acid, hydroiodic acid, fluoboric acid, and hexafluorophosphoric acid. Suitable amines include R⁵₃N, where R⁵ is an aryl or aliphatic group, or combinations thereof, for example an ARMEEN product, dodecylamine, hexadecylamine, octadecylamine, dioctadecylamine, tallowalkylamines, soyalkylamines, diocoalkylmethylamines, N,N-dimethylaniline, etc. Suitable solvent comprising THF, toluene, and the like, can also be combined with the intermediate borate, HCl, and amine.

An exemplary fourth process step according to this invention comprises:

X¹Mg⁺[B(C₆F₅)₃(C₆H₄OSiR²R³R⁴)]⁻+R⁵₃N+HX³(aqueous)→R⁵₃NH⁺[B(C₆F₅)₃(C₆H₄OH)]⁻+X¹MgX³+R²R³R⁴SiOH, or e.g.,

MgBr⁺[B(C₆F₅)₃(C₆H₄OSiEt₃)]⁻+R⁵₃N+HCl(aqueous)→R⁵₃NH⁺[B(C₆F₅)₃(C₆H₄OH)]⁻+MgBrCl+Et₃SiOH

In this fourth step, the SiR²R³R⁴ (e.g., triethylsilyl) protecting group is removed with aqueous HCl acid solution.

Another exemplary fourth process step according to this invention comprises:

Li⁺[B(C₆F₅)₃(C₆H₄OSiR²R³R⁴)]⁻+R⁵₃N+HCl(aqueous)→R⁵₃NH⁺[B(C₆F₅)₃(C₆H₄OH)]⁻+LiCl+R²R³R⁴SiOH

Another exemplary fourth process step according to this invention comprises:

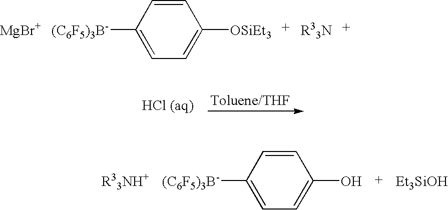

Produced magnesium halide salts are not shown as they are removed with the aqueous solvent.

Advantages of this invention are use of the SiR²R³R⁴ protection group as compared to other known protecting groups such as SiMe₃, which is less suitable for preventing cleavage of the Grignard, or SiMe₂(t-Bu), which requires more aggressive and less desirable deprotection agents such as amine HF salts. The SiR²R³R⁴ is easily removed with dilute acid solution, e.g., dilute HCl. Additionally, use of the at least 95 mol % pure borane allows for a one pot reaction from the borane to the final borate product without additional purification steps. Compared to known methods, this is a substantial improvement in yield, raw material utilization, and especially cycle time.

### EXAMPLES

### (1a) 4-Bromotriethylsilylbenzene using excess amine

In a 200 mL flask was placed 4-bromophenol (10.00 g, 57.8 mmol), a stir bar and 52 g of anhydrous THF (tetrahydrofuran). The solids dissolved easily. Triethylamine (8.77 g, 86.7 mmol) was then added, followed by dropwise addition of Et₃SiCl. White solids of triethylamine hydrochloride formed with each drop. The slurry became very viscous. More THF was added (total of 135 g) and the addition was completed. After stirring for 3 hours, the reaction was filtered on a 150 mL coarse frit. The solids were washed two times with 16 g of THF. The white cake was very compressible as the THF solvent was removed. After an hour, some solids had precipitated from the filtrate. The solution was refiltered on a medium frit. The volatiles were removed in vacuo leaving a clear, yellow liquid. The isolated yield was 15.88 g or 96% yield. The NMR showed a very clean BrC₆H₄OSiEt₃ product.

### (1b) 4-Bromotriethylsilylbenzene using near stoichiometric amount of NEt₃

Solid 4-bromophenol (2.00 g, 11.6 mmol) and triethylamine (1.21 g, 12.0 mmol) were dissolved in 27 grams of THF. Triethylsilylchloride (1.77 g, 11.7 mmol) was added dropwise to the magnetically stirred solution. A thick white slurry formed. After stirring for 3 hours, filtrate filtered easily on a coarse frit. The filtrate was transferred back to the reaction flask to remove remaining solids and refiltered. The cake was washed with a few mL of THF. NMR and GC confirmed complete reaction to BrC₆H₄OSiEt₃. Overnight, a small amount of white precipitate had formed and the solution was refiltered. No change in the NMR spectrum was detected.

### (2) BrMgC₆H₄OSiEt₃ formation

A portion (15.00 g, 52.2 mmol) of the BrC₆H₄OSiEt₃ produced in (1a) was diluted with 34 g of THF and set aside. In a round bottom flask was placed 1.50 g (61.7 mmol) of ECKA magnesium powder, 29 g of anhydrous THF and a stir bar. At ambient temperature, a couple pipettes of the BrC₆H₄OSiEt₃ solution were added to the stirred magnesium powder. No reaction was observed even after 1 hr. 1,2-dibromoethane was added (0.22 g) as an initiator. A small but steady temperature rise occurred immediately. Once the temperature began to fall, more of the BrC₆H₄SiEt₃ reagent was added. The reagent was added slowly in portions until complete. An exotherm was noted with each addition. The temperature was 35-43° C. during the addition. The slurry was stirred over the weekend before being worked up. Excess Mg was filtered off with a medium frit. The solids were washed with 7 g of THF. The NMR of the combined solution showed 16.74 wt % of the desired BrMgC₆H₄OSiEt₃ Grignard (82% yield).

### (3) Borate Synthesis

In a 250 mL round bottom flask was placed 99+% pure solid B(C₆F₅)₃ (8.04 g, 15.7 mmol) and 49.7 g of toluene. The solids nearly dissolved with stirring. THF was added to make a borane-THF complex (2.02 g, 28.0 mmol). The temperature rose to 31° C. The solution became clear and all of the solids dissolved. Grignard solution (30.55 g, 16.4 mmol) from (2) was then added. The temperature rose to 36.1° C. After the addition, the reaction was stirred for 4 hours and the clear yellow solution sampled. The aliquot was diluted with THF-d8; and a F NMR obtained indicates that about 5 mol % B(C₆F₅)₃ remained unconverted to the desired borate. H NMR indicated that about 1.8 mol % of Grignard had not yet reacted. As analyzed by NMR, the clear yellow solution comprised BrMg[B(C₆F₅)₃(C₆H₄OSiEt₃)].

After stirring overnight, an additional 1.21 g (0.65 mmol) of Grignard solution from (2) was added and the reaction was allowed to stir for 6 hours at ambient temperature; then the solution was again analyzed by F and H NMR. Absence of the starting borane was confirmed by F NMR.

### (4) [ArmeenH⁺][(C₆F₅)₃(C₆H₄OH)]

ARMEEN was analyzed by ¹H NMR with an internal standard. This ARMEEN is a mixture of tertiary amines with long chain aliphatic C16 and C18 groups and methyl groups. The effective molecular weight was determined to be 536.46 g/mol. ARMEEN solid (8.05 g) was dissolved in 24 g of toluene. The amine solution was then added to the clear yellow solution of BrMg[B(C₆F₅)₃(C₆H₄OSiEt₃)] from (3). No changes were observed. After stirring about 10 minutes, aqueous HCl was added until the pH was about 2 (35.3 g of 1.98 wt % HCl). The two phases became clear as the pH became acidic. After 15 min, the pH had risen to 5. More HCl solution was added (5.2 g) and the pH of the aqueous phase was reduced to 1. After another 15 minutes, the pH had not changed.

After stirring another 30 minutes, the aqueous acid layer was separated in a separatory funnel and washed with distilled water four times.

The cloudy, light yellow organic layer was analyzed by ¹H NMR to confirm the silyl group had been cleaved. The volatiles were then removed in vacuo with heating in a warm water bath. The first distillate (bulk) was just toluene. The second strip was at 1 mm Hg and 60° C. bath temperature for 3 hours. Upon cooling, a cloudy, extremely viscous oil remained in the pot (18.29 g). The oil was redissolved in 109.7 g toluene. The final product was analyzed. The concentration of [ArmeenH⁺][B(C₆F₅)₃(C6H₄OH)] was determined to be 10.04% by 1H NMR vs. an internal standard. The purity by 19F NMR was 99.5 mol %.

It is to be understood that this invention is not limited to any one specific embodiment exemplified herein. It is also to be understood that the reactants and components referred to by chemical name or formula anywhere in the specification or claims hereof, whether referred to in the singular or plural, are identified as they exist prior to being combined with or coming into contact with another substance referred to by chemical name or chemical type (e.g., another reactant, a solvent, or etc.). It matters not what chemical changes, transformations and/or reactions, if any, take place in the resulting combination or solution or reaction medium as such changes, transformations and/or reactions are the natural result of bringing the specified reactants and/or components together under the conditions called for pursuant to this disclosure. Thus the reactants and components are identified as ingredients to be brought together in connection with performing a desired chemical reaction or in forming a combination to be used in conducting a desired reaction. Accordingly, even though the claims hereinafter may refer to substances, components and/or ingredients in the present tense (“comprises”, “is”, etc.), the reference is to the substance, component or ingredient as it existed at the time just before it was first contacted, combined, blended or mixed with one or more other substances, components and/or ingredients in accordance with the present disclosure. Whatever transformations, if any, which occur in situ as a reaction is conducted is what the claim is intended to cover. Thus the fact that a substance, component or ingredient may have lost its original identity through a chemical reaction or transformation during the course of contacting, combining, blending or mixing operations, if conducted in accordance with this disclosure and with the application of common sense and the ordinary skill of a chemist, is thus wholly immaterial for an accurate understanding and appreciation of the true meaning and substance of this disclosure and the claims thereof. As will be familiar to those skilled in the art, the terms “combined”, “combining”, and the like as used herein mean that the components that are “combined” or that one is “combining” are put into a container with each other. Likewise a “combination” of components means the components having been put together in a container.

While the present invention has been described in terms of one or more preferred embodiments, it is to be understood that other modifications may be made without departing from the scope of the invention, which is set forth in the claims below.

1. A method of producing an activator comprising:
a. combining at least a halogenated phenol, a first amine and a trialkylsilyl halide to produce at least a protected phenol, wherein the trialkylsilyl halide comprises R²R³R⁴SiX², where R² is ethyl (Et), isopropyl (ⁱPr), or phenyl (Ph), R³ is methyl (Me), ethyl (Et), or phenyl (Ph), and R⁴ is methyl (Me) or ethyl (Et), Si is silicon, and X² is Cl (chloride), F (fluoride), B (bromide), or I (iodide);
b. combining at least the protected phenol and M to produce at least a Grignard or an aryllithium, where M comprises magnesium, lithium, or a lithium source;
c. combining at least the Grignard or aryllithium and a borane composition to produce at least an intermediate borate, wherein the borane composition comprises at least about 95 mol % borane; and
d. combining at least the intermediate borate, an acid composition, and a second amine to produce at least the activator.

2. The method of claim 1 wherein the first amine comprises R¹₃N, where R¹ is an aryl or an aliphatic group.

3. The method of claim 1 wherein the first amine comprises a heterocyclic nitrogen compound.

4. The method of claim 1 wherein the borane composition comprises at least about 95 mol % B(C₆F₅)₃.

5. The method of claim 1 wherein the acid composition comprises acetic acid, hydrochloric acid, hydrobromic acid, hydroiodic acid, fluoboric acid, or hexafluorophosphoric acid.

6. The method of claim 1 wherein the second amine comprises R⁵₃N, where R⁵ is an aryl or an aliphatic group, or combinations thereof.

7. A method of producing an activator comprising:
a. combining at least a halogenated phenol, a first amine and a trialkylsilyl halide to produce at least a protected phenol, wherein the trialkylsilyl halide comprises R²R³R⁴SiX², where R² is ethyl (Et), isopropyl (ⁱPr), or phenyl (Ph), R³ is methyl (Me), ethyl (Et), or phenyl (Ph), and R⁴ is methyl (Me) or ethyl (Et), Si is silicon, and X² is Cl (chloride), F (fluoride), B (bromide), or I (iodide);
b. combining at least the protected phenol and Mg to produce at least a Grignard;
c. combining at least the Grignard and a borane composition to produce at least an intermediate borate, wherein the borane composition comprises at least about 95 mol % borane; and
d. combining at least the intermediate borate, an acid composition, and a second amine to produce at least the activator.

8. A method of producing an activator comprising:
a. combining at least a halogenated phenol, a first amine and a trialkylsilyl halide to produce at least a protected phenol, wherein the trialkylsilyl halide comprises R²R³R⁴SiX², where R² is ethyl (Et), isopropyl (ⁱPr), or phenyl (Ph), R³ is methyl (Me), ethyl (Et), or phenyl (Ph), and R⁴ is methyl (Me) or ethyl (Et), Si is silicon, and X² is Cl (chloride), F (fluoride), B (bromide), or I (iodide);
b. combining at least the protected phenol and a lithium source to produce at least an aryllithium;
c. combining at least the aryllithium and a borane composition to produce at least an intermediate borate, wherein the borane composition comprises at least about 95 mol % borane; and
d. combining at least the intermediate borate, an acid composition, and a second amine to produce at least the activator.
